(19) United States
(12) Patent Application Publication
(10) Pub. No.: US 2014/0171616 A1
(43) Pub. Date: Jun. 19, 2014

(54) SELF-ADHESIVE COMPOSITION AND SELF-ADHESIVE FILM FOR GLASS MANUFACTURED THEREFROM

(71) Applicants: Seung Gweon Hong, Yuseong-gu (KR); Min Ho Jeon, Yuseong-gu (KR); Kwang Jin Chung, Yuseong-gu (KR); Ki Nam Chung, Yuseong-gu (KR); Myung Ahn Ok, Yuseong-gu (KR); In Hun Son, Yuseong-gu (KR)

(72) Inventors: Seung Gweon Hong, Yuseong-gu (KR); Min Ho Jeon, Yuseong-gu (KR); Kwang Jin Chung, Yuseong-gu (KR); Ki Nam Chung, Yuseong-gu (KR); Myung Ahn Ok, Yuseong-gu (KR); In Hun Son, Yuseong-gu (KR)

(73) Assignees: SK GLOBAL CHEMICAL CO., LTD., Seoul (KR); SK INNOVATION CO., LTD., Seoul (KR)

(21) Appl. No.: 14/234,691

(22) PCT Filed: Jun. 8, 2012
(86) PCT No.: PCT/KR2012/004552

§ 371 Date: Feb. 12, 2014

(30) Foreign Application Priority Data
Jul. 26, 2011 (KR) 10-2011-0073849

(51) Int. Cl. C09J 169/00

(52) U.S. Cl. CPC C09J 169/00
USPC 528/405

(57) ABSTRACT

Provided is a self-adhesive composition having excellent weather resistance, adhesive strength, transparency, and durability to durability against ultraviolet rays, containing aliphatic polycarbonate by copolymerization of carbon dioxide and at least one epoxide compound. Also, provided are a self-adhesive film for glass produced from the self-adhesive composition containing aliphatic polycarbonate and a use thereof.

### TECHNICAL FIELD

The present invention relates to a self-adhesive composition having excellent weather resistance, adhesive strength, transparency, and durability to durability against ultraviolet rays, containing aliphatic polycarbonate by copolymerization of carbon dioxide and at least one epoxide compound. The present invention also relates to a self-adhesive film for glass produced from the self-adhesive composition containing aliphatic polycarbonate and a use thereof.

### BACKGROUND ART

Recently, a surface protecting sheet has been used in various fields such as wooden products, metal products, glass products, plastic products, and the like, including electronic materials or precision machinery, in order to prevent damage such as scratches or the like during the process of storing or distributing. In addition, in order to prevent generation of scratches and the like on a vehicle body (metal portions, plastic portions, etc.,) during the process of storing or distributing of exportable vehicles or the like, a surface protecting film where an adhesive layer is formed on a polyolefin based resin film has been used. However, it is difficult to peel off a film for protection, which is attached to a glass surface, due to the degradation in strength or flexibility by ultraviolet rays, heat, and the like, the increase in adhesive strength as time passes, or the like, when storage is long-term storage under high outside temperature, like the above-described vehicle where the temperature at a roof thereof may reach 80° C. or higher due to outside exposure during the summer or the like.

In addition, in order to use the protecting film for the purpose of protecting a surface of the vehicle glass, the protecting film needs to be transparent so as to allow safe driving. The reason is that individual vehicles are frequently moved while having the protecting film attached thereto during the process of storing or distributing. Especially, the exportable vehicles or the like are often temporarily stored outdoors for several months to half a year until complete vehicles are delivered to consumers. However, in the case of the bad weather such as strong wind or typhoon during the period of storage or deliver, glass surfaces of the vehicles may be damaged by scratches or minute cracks due to small stones, sands, or the like. In general, when painting portions of the vehicle are damaged, partial repairing is possible by refinishing or the like. However, in the case of scratches or cracks generated on the glass of the vehicle, the glass needs to be completely replaced, resulting in large work and cost problems. Due to this, it is necessary to use protecting materials for protecting the glass surface at the time of shipment and storage of vehicles.

As an attempt to improve the above-described problems, a material for protecting a glass surface has been supposed. For example, a surface protecting film using an adhesive agent made of a polyethylene-acetic acid vinyl copolymer on a supporter made of polypropylene has been disclosed. However, according to this proposal, adhesive deposit may be generated after peeling thereof even during storage at about 80° C. under actual use environment, resulting in insufficient weather resistance and impact resistance. Therefore, it was found that this proposal is insufficient in applying to especially the glass of vehicles which need to be stored and protected outdoors.

Meanwhile, unlike the surface protecting sheet, there is disclosed a glass protecting sheet partially covering window glass of the vehicles with a cover sheet. However, this proposal may cause deterioration in cost and workability and also degrade transparency, and thus, is insufficient in applying to the glass of individual vehicles which need to be frequently moved during the process of storing and distributing.

In order to impart stability to glass and prevent scattering of pieces of broken glass, a film having high transparency and adhesive property, such as polyester, polyvinylbutyral (PVB), or EVA, has been used to be attached between double glasses. The adhesive film for glass is attached on the glass by heat compression or attached on the glass by using a high-weather resistant adhesive layer. In the case where heat compression is performed, it is general to perform lamination at a temperature of 140° C. or higher, and also in the case where the adhesive layer is used, it is general to perform thermal curing in the conditions of temperature or time required for curing the adhesive layer. As this film for safety glass becomes thicker, the glass needs to be thinner, which allows a total weight of a product to be decreased. For achieving this, the film needs to have a transparency level equal to or higher than that of the glass. The glass having the film attached thereon is used for safety glass or glass for solar light modules, and the film is required to have weather resistance and high transparency in order to improve efficiency.

### DISCLOSURE OF INVENTION

### Technical Problem

An object of the present invention is to provide a self-adhesive composition having excellent weather resistance, transparency, and durability against ultraviolet rays, and adhesive strength, and a high-transparent self-adhesive film that does not require an adhesive agent due to high adhesive strength to glass and does not degrade transparency even though the film becomes thicker.

### Solution to Problem

Hereinafter, the present invention will be described in more detail.

Here, unless indicated otherwise, the terms used in the specification including technical and scientific terms have the same meaning as those that are usually understood by those who skilled in the art to which the present invention pertains, and a detailed description of the known functions and constitutions that may obscure the gist of the present invention will be omitted.

The present invention is directed to a self-adhesive composition for manufacturing a film having excellent transparency, weather resistance, and adhesive strength, and more particularly to a self-adhesive composition containing aliphatic polycarbonate.

Especially, the aliphatic polycarbonate is prepared by copolymerization of carbon dioxide and at least one epoxide compound selected from the group consisting of (C2-C20)alkyleneoxide substituted or unsubstituted with halogen, (C1-C20)alkyloxy, (C6-C20)aryloxy, or (C6-C20)ar(C1-C20)alkyl(aralkyl)oxy; (C4-C20)cycloalkyleneoxide substituted or unsubstituted with halogen, (C1-C20)alkyloxy, (C6-C20)aryloxy or (C6-C20)ar(C1-C20)alky(aralkyl)oxy; and (C8-C20)styreneoxide substituted or unsubstituted with halogen, (C1-C20)alkyloxy, (C6-C20)aryloxy, (C6-C20)ar(C1-C20)alkyl(aralkyl)oxy or (C1-C20)alkyl.

More specifically, the epoxide compound may be at least one selected from the group consisting of ethylene oxide, propylene oxide, butene oxide, pentene oxide, hexene oxide, octene oxide, decene oxide, dodecene oxide, tetradecene oxide, hexadecene oxide, octadecene oxide, butadiene monoxide, 1,2-epoxide-7-octene, epifluorohydrin, epichlorohydrin, epibromohydrin, glycidyl methyl ether, glycidyl ethyl ether, glycidyl normalpropyl ether, glycidyl sec-butyl ether, glycidyl normal or isopentyl ether, glycidyl normalhexyl ether, glycidyl normalheptyl ether, glycidyl normaloctyl or 2-ethyl-hexyl ether, glycidyl normal or isononyl ether, glycidyl normaldecyl ether, glycidyl normaldodecyl ether, glycidyl normaltetradecyl ether, glycidyl normalhexadecyl ether, glycidyl normaloctadecyl ether, glycidyl normalicocyl ether, isopropyl glycidyl ether, butyl glycidyl ether, t-butyl glycidyl ether, 2-ethylhexyl glycidyl ether, allyl glycidyl ether, cyclopentene oxide, cyclohexene oxide, cyclooctene oxide, cyclododecene oxide, alpha-pinene oxide, 2,3-epoxide norbonene, limonene oxide, dieldrin, 2,3-epoxide propyl benzene, styrene oxide, phenyl propylene oxide, stilbene oxide, chlorostilbene oxide, dichlorostilbene oxide, 1,2-epoxy-3-phenoxypropane, benzyl oxymethyl oxirane, glycidyl-methylphenyl ether, chlorophenyl-2,3-epoxide propyl ether, epoxypropyl methoxyphenyl ether, biphenyl glycidyl ether, glycidyl naphthyl ether, glycidyl acetic acid ester, glycidyl propionate, glycidyl butanoate, glycidyl normalpentanoate, glycidyl normalhexanoate, glycidyl heptanoate, glycidyl normaloctanoate, glycidyl 2-ethyl hexanoate, glycidyl normalnonanoate, glycidyl normaldecanoate, glycidyl normaldodecanoate, glycidyl normaltetradecanoate, glycidyl normaihexadecanoate, glycidyl normaloctadecanoate, and glycidyl icosanoate.

In addition, the aliphatic polycarbonate may be represented by Chemical Formula 1 below.

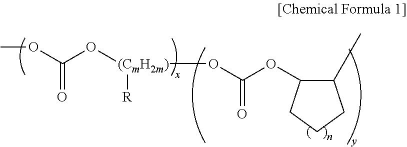

[in Chemical Formula 1, m is an integer of 2 to 10; n is an integer of 1 to 3; R is hydrogen, (C1-C4)alkyl, or —CH₂—O—R′ (R′ is (C1-C8)alkyl); x is an integer of 5 to 100; and y is an integer of 0 to 100.]]

More specifically, the aliphatic polycarbonate may be selected from poly(propylene carbonate) (PPC) obtained by copolymerization of polypropylene oxide and carbon dioxide; poly(propylene-cyclohexene carbonate) (PPCC) obtained by copolymerization of propylene oxide, cyclohexene oxide, and carbon dioxide; terpolymer obtained by copolymerization of propylene oxide, C1-C10 alkyl glycidyl ether, and carbon dioxide; and terpolymer obtained by copolymerization of propylene oxide, C1-C20 fatty acid glycidyl ester and carbon dioxide.

The aliphatic polycarbonate is prepared by copolymerization of carbon dioxide and at least one epoxide compound while using a complex compound of Chemical Formula 2 below as a catalyst.

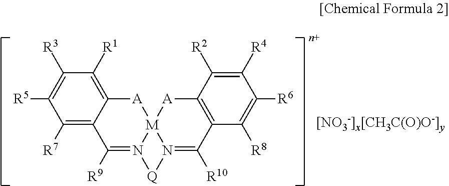

[in Chemical Formula 2, M is trivalent cobalt or trivalent chromium; A is oxygen or sulfur; Q is a diradical linking two nitrogen atoms; R¹ through R¹⁰ each are independently hydrogen; halogen; (C1-C20)alkyl; (C1-C20)alkyl containing at least one of halogen, nitrogen, oxygen, silicon, sulfur and phosphor; (C2-C20)alkenyl; (C2-C20)alkenyl containing at least one of halogen, nitrogen, oxygen, silicon, sulfur and phosphor; (C1-C20)alkyl(C6-C20)aryl; (C1-C20)alkyl(C6-C20)aryl containing at least one of halogen, nitrogen, oxygen, silicon, sulfur and phosphor; (C6-C20)aryl(C1-C20)alkyl; (C6-C20)aryl(C1-C20)alkyl containing at least one of halogen, nitrogen, oxygen, silicon, sulfur and phosphor; (C1-C20)alkoxy; (C6-C30)aryloxy; formyl; (C1-C20)alkylcarbonyl; (C6-C20)arylcarbonyl; or a metalloid radical of Group 14 metal substituted with hydrocarbyl; two of R¹ through R¹⁰ may be linked to each other to form a ring; at least one of R³ through R¹⁰ is a protonated group selected from the group consisting of Chemical Formulas a, b, and c below;

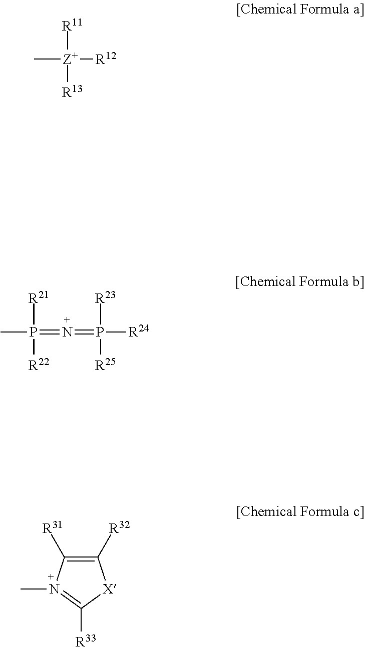

Z is nitrogen or phosphor;

R¹¹, R¹², R¹³, R²¹, R²², R²³, R²⁴, and R²⁵ each are independently (C1-C20)alkyl; (C1-C20)alkyl containing at least one of halogen, nitrogen, oxygen, silicon, sulfur and phosphor; (C2-C20)alkenyl; (C2-C20)alkenyl containing at least one of halogen, nitrogen, oxygen, silicon, sulfur and phosphor; (C1-C20)alkyl(C6-C20)aryl; (C1-C20)alkyl(C6-C20)aryl containing at least one of halogen, nitrogen, oxygen, silicon, sulfur and phosphor; (C6-C20)aryl(C1-C20)alkyl; (C6-C20)aryl(C1-C20)alkyl containing at least one of halogen, nitrogen, oxygen, silicon, sulfur and phosphor; or a metalloid radical of Group 14 metal substituted with hydrocarbyl; and two of R¹¹, R¹² and R¹³, or two of R²¹, R²², R²³, R²⁴, and R²⁵ may be linked to each other to form a ring;

R³¹, R³² and R³³ each are independently hydrogen; (C1-C20)alkyl; (C1-C20)alkyl containing at least one of halogen, nitrogen, oxygen, silicon, sulfur and phosphor; (C2-C20)alkenyl; (C2-C20)alkenyl containing at least one of halogen, nitrogen, oxygen, silicon, sulfur and phosphor; (C1-C20)alkyl(C6-C20)aryl; (C1-C20)alkyl(C6-C20)aryl containing at least one of halogen, nitrogen, oxygen, silicon, sulfur and phosphor; (C6-C20)aryl(C1-C20)alkyl; (C6-C20)aryl(C1-C20)alkyl containing at least one of halogen, nitrogen, oxygen, silicon, sulfur and phosphor; or a metalloid radical of Group 14 metal substituted with hydrocarbyl; and two of R³¹, R³² and R³³ may be linked to each other to form a ring;

X′ is oxygen, sulfur, or N—R (here, R is (C1-C20)alkyl);

a is a value obtained by adding 1 to the number of protonated groups included in R³ through R¹⁰;

b is an integer of 1 or greater, and a value of b+c equals to the value of a; and

a nitrate or acetate anion may be coordinated to M.]

In particular, Q may be selected from (C6˜C30)arylene, (C1˜C20)alkylene, (C2˜C20)alkenylene, (C2˜C20)alkynylene, or (C3˜C20)cycloalkylene.

The aliphatic polycarbonate of Chemical Formula 1 above may be prepared by solution polymerization or bulk polymerization, and more specifically, polymerization is performed by feeding carbon dioxide in the presence of one or two or more different epoxide compounds and a catalyst while using an organic solvent as a reactive medium. As the organic solvent, aliphatic hydrocarbons, such as, pentane, octane, decane, cyclohexane, and the like; aromatic hydrocarbons, such as, benzene, toluene, xylene, and the like; and halogenated hydrocarbons, such as, chloromethane, methylene chloride, chloroform, carbontetrachloride, 1,1-dichloroethane, 1,2-dichloethane, ethylchloride, trichloroethane, 1-chloropropane, 2-chloropropane, 1-chlorobutane, 2-chlorobutane, 1-chloro-2-methylpropane, chlorobenzene, bromobenzene, and the like, may be used alone or in combination of two or more thereof. The pressure of carbon dioxide may be normal pressure to 100 atm, and preferably, 5 atm to 30 atm may be appropriate. The polymerization temperature at the time of copolymerization may be 20˜120° C., and preferably, 50˜90° C. may be appropriate. Bulk polymerization using a monomer itself as a solvent may be more preferable.

The self-adhesive film according to the present invention is attached to a substrate by heat without an adhesive layer. As an aspect thereof, polypropylene carbonate is manufactured into a sheet having a predetermined thickness by using blowing, roll mill, press, or the like at 120˜160° C., and fine concavo-convex is imparted to a surface of the sheet by using a roll mill having a concavo-convex surface, so that when the self-adhesive film is attached onto a substrate such as a glass, an interlayer air between the substrate and the sheet easily escapes.

At the time of manufacturing the sheet, 1˜95 wt % of polylactic acid (PLA) is blended beforehand to polypropylene carbonate to manufacture the sheet, or 1˜30 wt % of plasticizer is again added thereto to manufacture the sheet in the above process condition. In addition, the sheet may be manufactured by mixing 1˜30% of plasticizer to polypropylene carbonate thereto, and here, the process temperature is set to 120˜150° C. As the plasticizer, glycerol carbonate, ester based adduct or ethylene oxide adduct of glycerol carbonate may be used. Also, propylene carbonate, ethylene carbonate, or the like may be used as the plasticizer.

The present invention is characterized by using a complex compound of Chemical Formula 3 below as a catalyst at the time of preparation of aliphatic polycarbonate.

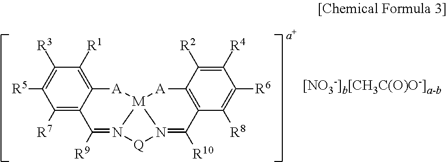

In Chemical Formula 3, M is trivalent cobalt or trivalent chromium; A is an oxygen or sulfur atom; Q is (C6˜C30)arylene, (C1˜C20)alkylene, (C2˜C20)alkenylene, (C2˜C20)alkynylene, or (C3˜C20)cycloalkylene; R¹ and R² each are independently primary (C1-C20)alkyl; R³ through R¹⁰ each are independently hydrogen; halogen; (C1-C20)alkyl; (C1-C20)alkyl containing at least one of halogen, nitrogen, oxygen, silicon, sulfur and phosphor; (C2-C20)alkenyl; (C2-C20)alkenyl containing at least one of halogen, nitrogen, oxygen, silicon, sulfur and phosphor; (C1-C20)alkyl(C6-C20)aryl; (C1-C20)alkyl(C6-C20)aryl containing at least one of halogen, nitrogen, oxygen, silicon, sulfur and phosphor; (C6-C20)aryl(C1-C20)alkyl; (C6-C20)aryl(C1-C20)alkyl containing at least one of halogen, nitrogen, oxygen, silicon, sulfur and phosphor; (C1-C20)alkoxy; (C6-C30)aryloxy; formyl; (C1-C20)alkylcarbonyl; (C6-C20)arylcarbonyl; or a metalloid radical of Group 14 metal substituted with hydrocarbyl; two of R1 through R10 may be linked to each other to form a ring; at least three of R3 through R10 each are a protonated group selected from the group consisting of Chemical Formulas a, b, and c;

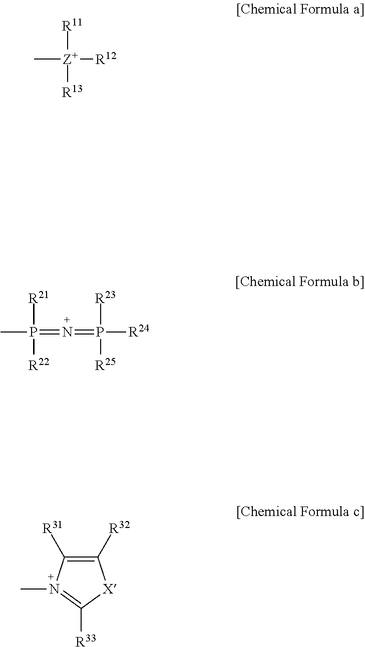

Z is nitrogen or phosphor;

R¹¹, R¹², R¹³, R²¹, R²², R²³, R²⁴, and R²⁵ each are independently (C1-C20)alkyl; (C1-C20)alkyl containing at least one of halogen, nitrogen, oxygen, silicon, sulfur and phosphor; (C2-C20)alkenyl; (C2-C20)alkenyl containing at least one of halogen, nitrogen, oxygen, silicon, sulfur and phosphor; (C1-C20)alkyl(C6-C20)aryl; (C1-C20)alkyl(C6-C20)aryl containing at least one of halogen, nitrogen, oxygen, silicon, sulfur and phosphor; (C6-C20)aryl(C1-C20)alkyl; (C6-C20)aryl(C1-C20)alkyl containing at least one of halogen, nitrogen, oxygen, silicon, sulfur and phosphor; or a metalloid radical of Group 14 metal substituted with hydrocarbyl; and two of R¹¹, R¹² and R¹³, or two of R²¹, R²², R²³, R²⁴, and R²⁵ may be linked to each other to form a ring; R³¹, R³² and R³³ each are independently hydrogen; (C1-C20)alkyl; (C1-C20)alkyl containing at least one of halogen, nitrogen, oxygen, silicon, sulfur and phosphor; (C2-C20)alkenyl; (C2-C20)alkenyl containing at least one of halogen, nitrogen, oxygen, silicon, sulfur and phosphor; (C1-C20)alkyl(C6-C20)aryl; (C1-C20)alkyl(C6-C20)aryl containing at least one of halogen, nitrogen, oxygen, silicon, sulfur and phosphor; (C6-C20)aryl(C1-C20)alkyl; (C6-C20)aryl(C1-C20)alkyl containing at least one of halogen, nitrogen, oxygen, silicon, sulfur and phosphor; or a metalloid radical of Group 14 metal substituted with hydrocarbyl; two of R³¹, R³² and R³³ may be linked to each other to form a ring; X′ is oxygen, sulfur, or N—R (here, R is (C1-C20)alkyl); a is a value obtained by adding 1 to the number of protonated groups contained in R³ through R¹⁰; b is an integer of 1 or greater; and a nitrate or acetate anion may be coordinated to M.]

In addition, in the complex compound represented by Chemical Formula 3, M is trivalent cobalt; A is oxygen; Q is trans-1,2-cyclohexylene, phenylene, or ethylene; R¹ and R² each are independently methyl or ethyl; R³ through R¹⁰ each are independently hydrogen or —[YR⁴¹₃₋ₘ{(CR⁴²R⁴³)ₙN⁺R⁴⁴R⁴⁵R⁴⁶}ₘ]; Y is C or Si; R⁴¹, R⁴², R⁴³, R⁴⁴R⁴⁵ and R⁴⁶ each are independently hydrogen; (C1-C20)alkyl; (C1-C20)alkyl containing at least one of halogen, nitrogen, oxygen, silicon, sulfur and phosphor; (C2-C20)alkenyl; (C2-C20)alkenyl containing at least one of halogen, nitrogen, oxygen, silicon, sulfur and phosphor; (C1-C20)alkyl(C6-C20)aryl; (C1-C20)alkyl(C6-C20)aryl containing at least one of halogen, nitrogen, oxygen, silicon, sulfur and phosphor; (C6-C20)aryl(C1-C20)alkyl; (C6-C20)aryl(C1-C20)alkyl containing at least one of halogen, nitrogen, oxygen, silicon, sulfur and phosphor; or a metalloid radical of Group 14 metal substituted with hydrocarbyl; and two of R⁴⁴, R⁴⁵, and R⁴⁶ may be linked to each other to form a ring; m is an integer of 1 to 3, and n is an integer of 1 to 20; provided that at least three of R³ through R¹⁰ each are —[YR⁴¹₃₋ₘ{(CR⁴²R⁴³)ₙN⁺R⁴⁴R⁴⁵R⁴⁶}ₘ] when m is 1; at least two of R³ through R¹⁰ each are —[YR⁴¹₃₋ₘ{(CR⁴²R⁴³)ₙN⁺R⁴⁴R⁴⁵R⁴⁶}ₘ] when m is 2; and at least one of R³ through R¹⁰ is —[YR⁴¹₃₋ₘ{(CR⁴²R⁴³)ₙN⁺R⁴⁴R⁴⁵R⁴⁶}ₘ] when m is 3. each are —[YR⁴¹₃₋ₘ{(CR⁴²R⁴³)ₙN+R⁴⁴R⁴⁵R⁴⁶}ₐ] when m is 1; at least two of R³ through R¹⁰ each are —[YR⁴¹₃₋ₘ{(CR⁴²R⁴³)ₙN+R⁴⁴R⁴⁵R⁴⁶}ₘ] when m is 2; and at least one of R³ through R¹⁰ is —[YR⁴¹₃₋ₘ{(CR⁴²R⁴³)ₙN+R⁴⁴R⁴⁵R⁴⁶}ₘ] when m is 3.

The present invention is directed to a self-adhesive film for glass, manufactured from the self-adhesive composition containing aliphatic polycarbonate. The self-adhesive film has excellent transparency and durability against ultraviolet rays and high adhesive strength to the glass, and thus, the self-adhesive film can be used without an adhesive agent.

The glass may be used as safety glass for building, safety glass for vehicles (Windshield), safety glass for airplanes, or glass for solar light modules.

In addition, with respect to a solar cell module, when the self-adhesive film for glass is used for glass for the solar cell module, resulting in excellent transparency and durability against ultraviolet rays.

In addition, the self-adhesive film requires stronger adhesive strength, and thus, when an adhesive agent is used together therewith, the self-adhesive film has excellent wettability to a surface thereof and high polarity. Therefore, the self-adhesive film has excellent compatibility with various adhesive agents. As the adhesive agent having the above purpose, an adhesive agent where polycarbonate using bisphenol A as a source is dissolved in a solvent may be used or the same polycarbonate film may be used by thermal attachment.

In addition, polyamide wax or quaternary ammonium salt or tertiary fatty acid amine containing a long chain of 8 to 24 carbons for improving thermal stability; a light stabilizer for improving ultraviolet stability; and a hydroquinone based oxidation stabilizer retarding oxidation by air may be added to the self-adhesive composition in 0.01˜1%, respectively.

### Advantageous Effects of Invention

The self-adhesive film for glass according to the present invention can enhance safety against to breakage of glass without the loss of transmittance even with increased thickness thereof by improving transparency and adhesive property thereof. Further, the self-adhesive film for glass according to the present invention can be used by simple thermal attachment without an adhesive agent, and thus, a lamination process can be simplified. Further, the self-adhesive film for glass according to the present invention has no fear of moisture adsorption even though it is exposed to air, unlike the existing PVB, and thus, temperature, humidity, and the like need not be controlled during delivery, storage, and construction, thereby simplifying the entire process from production to construction.

### BEST MODE FOR CARRYING OUT THE INVENTION

Hereinafter, the present invention will be understood and appreciated more fully from the following examples, and the examples are for illustrating the present invention and not for limiting the present invention.

[Evaluation]

1. Water Absorption: Heating was performed from 35° C. to 250° C. at a temperature rise rate of 10° C./min, to analyze weight change, and then water absorption was calculated and evaluated therefrom.

2. Adhesive Strength: Adhesive strength was evaluated by a peeling strength measurement method according to the JIS C 6481 standard.

3. UV Aging: UV aging was evaluated by measuring the yellow index (YI), which is a transparency degree of plastic at which the color is changed to yellow at the time of long exposure to light.

### Preparation Example 1

### Synthesis of 3-methyl-5-[{BF₄⁻Bu₃N⁺(CH₂)₃}₂CH}]-salicylaldehyde compound

The ligand having a structure below was hydrolyzed to prepare a title compound. The compound was synthesized by the known method (Angew. Chem. Int. Ed., 2008, 47, 7306-7309).

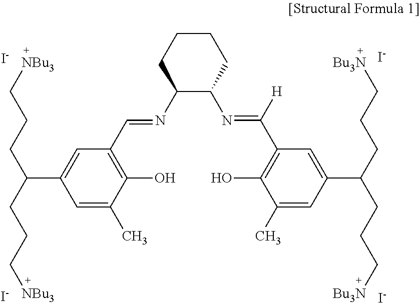

The compound (0.500 g, 0.279 mmol) of Structural Formula 1 was dissolved in methylene chloride (4 mL), and then an aqueous HI solution (2 N, 2.5 mL) was added thereto, followed by stirring at 70° C. for 3 hours. The water layer was removed and the methylene chloride layer was washed with water. Then, the water was removed by anhydrous magnesium chloride and the solvent was removed under reduced pressure. Purification was performed by using silica gel column chromatography with methylenechloride/ethanol (10:1), to thereby obtain 0.462 g of 3-methyl-5-[{I⁻Bu₃N⁺(CH₂)₃}₂CH}]-salicylaldehyde (yield, 95%). This compound was dissolved in ethanol (6 mL), and then AgBF4 (0.225 g, 1.16 mmol) was added thereto. Stirring was performed at room temperature for 1.5 hours, followed by filtering. The solvent was removed under reduced pressure, and purification was performed by using silica gel column chromatography with methylenechloride/ethanol (10:1), to thereby obtain 0.410 g of 3-methyl-5-[{BF₄⁻Bu₃N⁺(CH₂)₃}₂CH}]-salicylaldehyde (yield, 100%).

¹H NMR (CDCl₃): δ 11.19 (s, 1H, OH), 9.89 (s, 1H, CHO), 7.48 (s, 1H, m-H), 7.29 (s, 1H, m-H), 3.32-3.26 (m, 4H, —NCH₂), 3.10-3.06 (m, 12H, —NCH₂), 2.77 (septet, J=6.8 Hz, 1H, —CH—), 2.24 (s, 3H, —CH₃), 1.76-1.64 (m, 8H, —CH₂), 1.58-1.44 (m, 16H, —CH₂), 1.34-1.29 (m, 8H, —CH₂), 0.90 (t, J=7.6 Hz, 18H, CH₃) ppm. ¹³C {¹H}NMR (CDCl₃): δ 197.29, 158.40, 136.63, 133.48, 130.51, 127.12, 119.74, 58.23, 40.91, 32.51, 23.58, 19.48, 18.82, 15.10, 13.45 ppm.

### Preparation Example 2

### Synthesis of Complex Compound 1

Complex Compound 1 of Chemical Formula 13 below synthesized from the 3-methyl-5-[{BF₄⁻Bu₃N⁺(CH₂)₃}₂CH}]-salicylaldehyde compound obtained by Preparation Example 1.

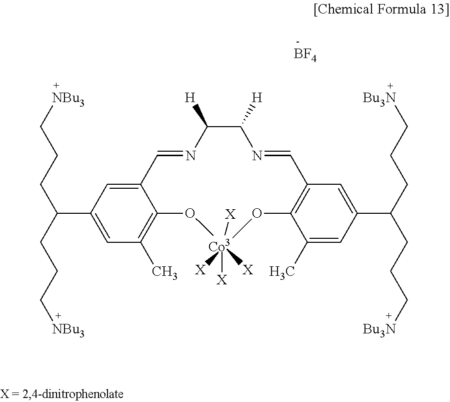

Ethylene diamine dihydrochloride (10 mg, 0.074 mmol), sodium t-butoxide (14 mg), and the 3-methyl-5-[{BF₄⁻Bu₃N⁺(CH₂)₃}₂CH}]-salicylaldehyde compound (115 mg) obtained by Preparation Example 1 were weighed with vial in a dry box, and ethanol (2 mL) was added thereto, followed by stirring overnight at room temperature. The reaction mixture was filtered, and the filtrate was taken out and then ethanol was removed under reduced pressure. This was again dissolved in methylene chloride, followed by again filtering. The solvent was removed under reduced pressure, and Co(OAc)₂ (13 mg, 0.074 mmol) and ethanol (2 mL) were added thereto. The reaction mixture was stirred at room temperature for 3 hours, and then the solvent was removed under reduced pressure. The thus obtained compound was washed with diethylether (2 mL) twice, to thereby obtain a solid compound. This solid compound was again dissolved in methylene chloride (2 mL), and then 2,4-dinitrophenol (14 mg, 0.074 mmol) was added thereto, followed by stirring for 3 hours in the presence of oxygen. The reaction mixture was added to sodium 2,4-dinitrophenolate (92 mg, 0.44 mmol), followed by stirring overnight. Filtering using cellite was performed and the solvent was removed, to thereby obtain a black brown solid compound (149 mg, 100%). ¹H NMR (dmso-d₆,40° C.): δ 8.84 (br, 2H, (NO₂)₂C₆H₃O), 8.09 (br, 2H, (NO₂)₂C₆H₃O), 8.04 (s, 1H, CH, N), 7.12 (s, 2H, m-H), 6.66 (br, 2H, (NO₂)₂C₆H₃O), 4.21 (br, 2H, ethylene-C H₂), 3.35-2.90 (br, 16H, NCH₂), 2.62 (s, 3H, CH₃), 1.91 (s, 1H, CH), 1.68-1.42 (br, 20H, CH₂), 1.19 (br, 12H, CH₂), 0.83 (br, 18H, CH₃) ppm. ¹H NMR (THF-d₈,20° C.): δ 8.59 (br, 1H, (NO₂)₂C₆H₃O), 8.10 (br, 1H, (NO₂)₂C₆H₃O), 7.93 (s, 1H, CH, N), 7.88 (br, 1H, (NO₂)₂C₆H₃O), 7.05 (s, 1H, m-H), 6.90 (s, 1H, m-H), 4.51 (s, 2H, ethylene-CH₂), 3.20-2.90 (br, 16H, NCH₂), 2.69 (s, 3H, CH₃), 1.73 (s, 1H, CH), 1.68-1.38 (br, 20H, CH₂), 1.21 (m, 12H, CH₂), 0.84 (t, J=6.8 Hz, 18H, CH₃) ppm. ¹H NMR (CD₂Cl₂,20° C.): δ 8.43 (br, 1H, (NO₂)₂C₆H₃O), 8.15 (br, 1H, (NO₂)₂C₆H₃O), 7.92 (br, 1H, (NO₂)₂C₆H₃O), 7.79 (s, 1H, CH, N), 6.87 (s, 1H, m-H), 6.86 (s, 1H, m-H), 4.45 (s, 2H, ethylene-CH₂), 3.26 (br, 2H, NCH₂), 3.0-2.86 (br, 14H, NCH₂), 2.65 (s, 3H, CH₃), 2.49 (br, 1H, CH), 1.61-1.32 (br, 20H, CH₂), 1.31-1.18 (m, 12H, CH₂), 0.86 (t, J=6.8 Hz, 18H, CH₃) ppm. 13C{¹H}NMR (dmso-d₆,40° C.): δ 170.33, 165.12, 160.61, 132.12 (br), 129.70, 128.97, 127.68 (br), 124.51 (br), 116.18 (br), 56.46, 40.85, 31.76, 21.92, 18.04, 16.16, 12.22 ppm. ¹⁵N{¹H}NMR (dmso-d₆,20° C.): δ −156.32, −159.21 ppm. 15N{¹H}NMR (THF-d₈, 20° C.): δ −154.19 ppm. 19F{¹H}NMR (dmso-d₆,20° C.): δ −50.63, −50.69 ppm.

### Preparation Example 3

### Synthesis of Copolymer (PPC) Using Carbon Dioxide/Propylene Oxide

Propylene oxide (1162 g, 20.0 mol) in which a complex compound (0.454 g, which is an amount calculated according to a monomer/catalyst ratio) was dissolved was injected to a 3 L-autoclave reactor through a cannula. As the complex compound, Complex Compound 1 prepared according to Preparation Example 2 was used. Carbon dioxide was injected to the reactor at a pressure of 17 bar, and stirring was performed within a circulation water bath of which the temperature was set to 80° C. in advance while increasing the temperature of the reactor. After 30 minutes, the time point when the pressure of the carbon dioxide starts to fall was measured and recorded, and reaction was performed for 2 hours from the time point, and then the reaction was finished by degassing of carbon dioxide. 830 g of propylene oxide was further added to the thus obtained viscous solution to thereby lower viscosity of the solution. Then, the resulting solution was passed through silica gel (50 g, Mere company, 0.040˜0.063 mm particle size (230˜400 mesh)) pads, to thereby obtain a colorless solution. The resulting solution was subjected to reduced pressure to remove the monomer, to thereby obtain 283 g of white solid. The thus obtained polymer had a weight average molecular weight (Mw) of 290,000 and a polydispersity index (PDI) of 1.30. The weight average molecular weight and polydispersity index of the thus obtained polymer were measured by using GPC.

### Preparation Example 4

### Synthesis of Terpolymer (CO2/PO/CHO Terpolymer) Using Carbon Dioxide/Propylene Oxide/Cyclohexene Oxide

Propylene oxide (622.5 g, 10.72 mol) in which a complex compound (0.406 g, which is an amount calculated according to a monomer/catalyst ratio) was dissolved was injected to a 3 L-autoclave reactor through a cannula. As the complex compound, Complex Compound 1 prepared according to Preparation Example 2 was used. Carbon dioxide was injected to the reactor at a pressure of 17 bar, and stirring was performed within a circulation water bath of which the temperature was set to 80° C. in advance while increasing the temperature of the reactor. After 30 minutes, the time point when the pressure of the carbon dioxide starts to fall was measured and recorded, and reaction was performed for 2 hours from the time point, and then the reaction was finished by degassing of carbon dioxide. 830 g of propylene oxide was further added to the thus obtained viscous solution to thereby lower viscosity of the solution. Then, the resulting solution was passed through silica gel (50 g, Mere company, 0.040˜0.063 mm particle size (230˜400 mesh)) pads, to thereby obtain a colorless solution. The resulting solution is subjected to reduced pressure to remove the monomer, thereby obtaining 283 g of white solid.

The thus obtained polymer had a weight average molecular weight (Mw) of 210,000 and a polydispersity index of 1.26, and a ratio of the cyclohexene carbonate within the polymer was 25 mol %. The weight average molecular weight and polydispersity index of the thus obtained polymer were measured by using GPC, and the ratio of the cyclohexene carbonate within the polymer was calculated by analyzing 1H NMR spectrum.

### Example 1

PPC was manufactured into 0.5 m-thick sheets by using a hot press, and then cut into a size of 25 mm×10 mm. Then, the light transmittance at a visible ray region was measured by using a UV-Vis Spectrometer. Also, the same sheet was subjected to ultraviolet irradiation, and color change of the sheet was measured for 3 days. The same sheet was interposed between a pair of 25 mm×100 mm glasses overlapping each other by 10 mm, and attached at 160° C. Then the peeling test was performed by using UTM. PPC was used to manufacture a 50 μm-thick film, and moisture permeability thereof was measured. The measurement results were tabulated in Table 1.

### Example 2

PPCC was used instead of PPC in Example 1.

### Comparative Example 1

PVB was used instead of PPC in Example 1.

### Comparative Example 2

EVA was used instead of PPC in Example 1.

TABLE 1

| | | | Comparative | Comparative |
|---|---|---|---|---|
| | Example | Example 2 | Example 1 | Example 2 |
| | 1 PPC | PPCC | PVB | EVA |
| Thickness, mm | 0.7 | 0.7 | 0.5 | 0.5 |
| Light | 99% | 98% | 95% | 95% |
| transmittance | | | | |
| Water Absorption | <0.1 | <0.1 | >0.7 | <0.1 |
| (20 deg C. 24 h, %) | | | | |
| Peeling Strength | >39 | >37 | >36 | <35 |
| (N/cm) for glass | | | | |
| UV aging | 0 | 0.02 | 0.05 | 0.07 |
| (delta YI) | | | | |

As can be seen from the above results, the self-adhesive film for glass containing aliphatic polycarbonate of the present invention had excellent light transmittance and equal or higher level of adhesive strength as compared with the existing PVB or EVA.

1. A self-adhesive composition, comprising aliphatic polycarbonate by copolymerization of carbon dioxide and at least one epoxide compound selected from the group consisting of (C2-C20)alkyleneoxide substituted or unsubstituted with halogen, (C1-C20)alkyloxy, (C6-C20)aryloxy, or (C6-C20)ar(C1-C20)alkyl(aralkyl)oxy; (C4-C20)cycloalkyleneoxide substituted or unsubstituted with halogen, (C1-C20)alkyloxy, (C6-C20)aryloxy or (C6-C20)ar(C1-C20)alky(aralkyl)oxy; and (C8-C20)styreneoxide substituted or unsubstituted with halogen, (C1-C20)alkyloxy, (C6-C20)aryloxy, (C6-C20)ar(C1-C20)alkyl(aralkyl)oxy, or (C1-C20)alkyl.

2. The self-adhesive composition of claim 1, wherein the aliphatic polycarbonate is represented by Chemical Formula 1 below: 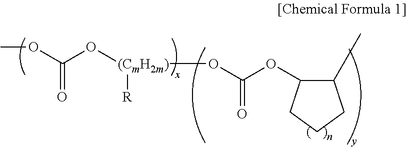
[in Chemical formula 1, m is an integer of 2 to 10; n is an integer of 1 to 3; R is hydrogen, (C1-C4)alkyl, or —CH₂—O—R′(R′ is (C1-C8)alkyl); x is an integer of 5 to 100; and y is an integer of 0 to 100.]

3. The self-adhesive composition of claim 1, wherein the epoxide compound is at least one selected from the group consisting of ethylene oxide, propylene oxide, butene oxide, pentene oxide, hexene oxide, octene oxide, decene oxide, dodecene oxide, tetradecene oxide, hexadecene oxide, octadecene oxide, butadiene monoxide, 1,2-epoxide-7-octene, epifluorohydrin, epichlorohydrin, epibromohydrin, glycidyl methyl ether, glycidyl ethyl ether, glycidyl normalpropyl ether, glycidyl sec-butyl ether, glycidyl normal or isopentyl ether, glycidyl normalhexyl ether, glycidyl normalheptyl ether, glycidyl normaloctyl or 2-ethyl-hexyl ether, glycidyl normal or isononyl ether, glycidyl normaldecyl ether, glycidyl normaldodecyl ether, glycidyl normaltetradecyl ether, glycidyl normalhexadecyl ether, glycidyl normaloctadecyl ether, glycidyl normalicocyl ether, isopropyl glycidyl ether, butyl glycidyl ether, t-butyl glycidyl ether, 2-ethylhexyl glycidyl ether, allyl glycidyl ether, cyclopentene oxide, cyclohexene oxide, cyclooctene oxide, cyclododecene oxide, alpha-pinene oxide, 2,3-epoxide norbonene, limonene oxide, dieldrin, 2,3-epoxide propyl benzene, styrene oxide, phenyl propylene oxide, stilbene oxide, chlorostilbene oxide, dichlorostilbene oxide, 1,2-epoxy-3-phenoxypropane, benzyl oxymethyl oxirane, glycidyl-methylphenyl ether, chlorophenyl-2,3-epoxide propyl ether, epoxypropyl methoxyphenyl ether, biphenyl glycidyl ether, glycidyl naphthyl ether, glycidyl acetic acid ester, glycidyl propionate, glycidyl butanoate, glycidyl normalpentanoate, glycidyl normalhexanoate, glycidyl heptanoate, glycidyl normaloctanoate, glycidyl 2-ethyl hexanoate, glycidyl normalnonanoate, glycidyl normaldecanoate, glycidyl normaldodecanoate, glycidyl normaltetradecanoate, glycidyl normalhexadecanoate, glycidyl normaloctadecanoate, and glycidyl icosanoate.

4. The self-adhesive composition of claim 1, wherein the aliphatic polycarbonate is selected from poly(propylene carbonate) (PPC) obtained by copolymerization of polypropylene oxide and carbon dioxide; poly(propylene-cyclohexene carbonate) (PPCC) obtained by copolymerization of propylene oxide, cyclohexene oxide, and carbon dioxide; terpolymer obtained by copolymerization of propylene oxide, C1-C10 alkyl glycidyl ether, and carbon dioxide; and terpolymer obtained by copolymerization of propylene oxide, C1-C20 fatty acid glycidyl ester and carbon dioxide.

5. The self-adhesive composition of claim 1, wherein the aliphatic polycarbonate is prepared by using a complex compound of Chemical Formula 2 below as a catalyst: 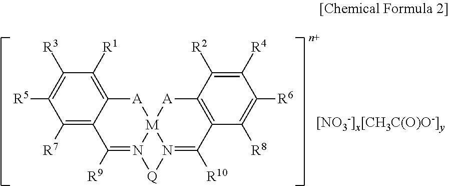
[in Chemical Formula 2, M is trivalent cobalt or trivalent chromium; A is oxygen or sulfur; Q is a diradical linking two nitrogen atoms; R¹ through R¹⁰ each are independently hydrogen; halogen; (C1-C20)alkyl; (C1-C20)alkyl containing at least one of halogen, nitrogen, oxygen, silicon, sulfur and phosphor; (C2-C20)alkenyl; (C2-C20)alkenyl containing at least one of halogen, nitrogen, oxygen, silicon, sulfur and phosphor; (C1-C20)alkyl(C6-C20)aryl; (C1-C20)alkyl(C6-C20)aryl containing at least one of halogen, nitrogen, oxygen, silicon, sulfur and phosphor; (C6-C20)aryl(C1-C20)alkyl; (C6-C20)aryl(C1-C20)alkyl containing at least one of halogen, nitrogen, oxygen, silicon, sulfur and phosphor; (C1-C20)alkoxy; (C6-C30)aryloxy; formyl; (C1-C20)alkylcarbonyl; (C6-C20)arylcarbonyl; or a metalloid radical of Group 14 metal substituted with hydrocarbyl; two of R¹ through R¹⁰ may be linked to each other to form a ring; at least one of R³ through R¹⁰ is a protonated group selected from the group consisting of Chemical Formulas a, b, and c below; 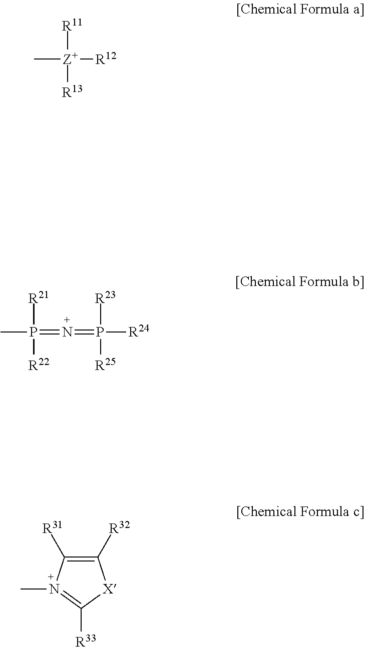
Z is nitrogen or phosphor;
R¹¹, R¹², R¹³, R²¹, R²², R²³, R²⁴, and R²⁵ each are independently (C1-C20)alkyl; (C1-C20)alkyl containing at least one of halogen, nitrogen, oxygen, silicon, sulfur and phosphor; (C2-C20)alkenyl; (C2-C20)alkenyl containing at least one of halogen, nitrogen, oxygen, silicon, sulfur and phosphor; (C1-C20)alkyl(C6-C20)aryl; (C1-C20)alkyl(C6-C20)aryl containing at least one of halogen, nitrogen, oxygen, silicon, sulfur and phosphor; (C6-C20)aryl(C1-C20)alkyl; (C6-C20)aryl(C1-C20)alkyl containing at least one of halogen, nitrogen, oxygen, silicon, sulfur and phosphor; or a metalloid radical of Group 14 metal substituted with hydrocarbyl; and two of R¹¹, R¹² and R¹³, or two of R²¹, R²², R²³, R²⁴, and R²⁵ may be linked to each other to form a ring; R³¹, R³² and R³³ each are independently hydrogen; (C1-C20)alkyl; (C1-C20)alkyl containing at least one of halogen, nitrogen, oxygen, silicon, sulfur and phosphor; (C2-C20)alkenyl; (C2-C20)alkenyl containing at least one of halogen, nitrogen, oxygen, silicon, sulfur and phosphor; (C1-C20)alkyl(C6-C20)aryl; (C1-C20)alkyl(C6-C20)aryl containing at least one of halogen, nitrogen, oxygen, silicon, sulfur and phosphor; (C6-C20)aryl(C1-C20)alkyl; (C6-C20)aryl(C1-C20)alkyl containing at least one of halogen, nitrogen, oxygen, silicon, sulfur and phosphor; or a metalloid radical of Group 14 metal substituted with hydrocarbyl; and two of R³¹, R³² and R³³ may be linked to each other to form a ring;
X′ is oxygen, sulfur, or N—R (here, R is (C1-C20)alkyl);
a is a value obtained by adding 1 to the number of protonated groups included in R³ through R¹⁰;
b is an integer of 1 or greater, and a value of b+c equals to the value of a; and
a nitrate or acetate anion may be coordinated to M.]

6. The self-adhesive composition of claim 5, wherein Q is selected from (C6˜C30)arylene, (C1˜C20)alkylene, (C2˜C20)alkenylene, (C2˜C20)alkynylene, or (C3˜C20)cycloalkylene.

7. The self-adhesive composition of claim 1, wherein the aliphatic polycarbonate has a weight average molecular weight of 50000˜300000 g/mole, and contains 1% or less of ether linkage.

8. A self-adhesive film for glass manufactured from the self-adhesive composition of claim 1, comprising aliphatic polycarbonate by copolymerization of carbon dioxide and at least one epoxide compound.

9. The self-adhesive composition of claim 8, wherein the glass is used for safety glass for building, safety glass for vehicles, safety glass for airplanes, or glass for solar light modules.

10. A solar cell module employing, as glass therefor, the self-adhesive film for glass of claim 8.

11. A self-adhesive film for glass manufactured from the self-adhesive composition of claim 2, comprising aliphatic polycarbonate by copolymerization of carbon dioxide and at least one epoxide compound.

12. A self-adhesive film for glass manufactured from the self-adhesive composition of claim 3, comprising aliphatic polycarbonate by copolymerization of carbon dioxide and at least one epoxide compound.

13. A self-adhesive film for glass manufactured from the self-adhesive composition of claim 4, comprising aliphatic polycarbonate by copolymerization of carbon dioxide and at least one epoxide compound.

14. A self-adhesive film for glass manufactured from the self-adhesive composition of claim 5, comprising aliphatic polycarbonate by copolymerization of carbon dioxide and at least one epoxide compound.

15. A self-adhesive film for glass manufactured from the self-adhesive composition of claim 7, comprising aliphatic polycarbonate by copolymerization of carbon dioxide and at least one epoxide compound.

16. The self-adhesive composition of claim 11, wherein the glass is used for safety glass for building, safety glass for vehicles, safety glass for airplanes, or glass for solar light modules.

17. The self-adhesive composition of claim 12, wherein the glass is used for safety glass for building, safety glass for vehicles, safety glass for airplanes, or glass for solar light modules.

18. The self-adhesive composition of claim 13, wherein the glass is used for safety glass for building, safety glass for vehicles, safety glass for airplanes, or glass for solar light modules.

19. The self-adhesive composition of claim 14, wherein the glass is used for safety glass for building, safety glass for vehicles, safety glass for airplanes, or glass for solar light modules.

20. The self-adhesive composition of claim 15, wherein the glass is used for safety glass for building, safety glass for vehicles, safety glass for airplanes, or glass for solar light modules.
